(19) United States
(12) Patent Application Publication
(10) Pub. No.: US 2026/0112351 A1
(43) Pub. Date: Apr. 23, 2026

(54) AUDIO FEEDBACK SUPPRESSION METHOD AND SYSTEM

(71) Applicant: Tymphany HK Limited, Hong Kong (HK)

(72) Inventor: JIN-LING ZHUANG, Taipei City (TW)

(21) Appl. No.: 19/308,572

(22) Filed: Aug. 25, 2025

Related U.S. Application Data
(60) Provisional application No. 63/709,667, filed on Oct. 21, 2024.

(51) Int. Cl. G10K 11/178

(52) U.S. Cl. CPC G10K 11/17821; G10K 11/17853

(57) ABSTRACT

An audio feedback suppression method includes performing a first frequency analysis of an audio signal at a first frequency resolution, performing a second frequency analysis of the audio signal at a second frequency resolution higher than the first frequency resolution, and suppressing audio feedback frequencies in the audio signal based on the first frequency analysis and the second frequency analysis.

### CROSS REFERENCE TO RELATED APPLICATIONS

This application claims priority of U.S. Provisional Application No. 63/709,667 filed on Oct. 21, 2024 under 35 U.S.C. § 119(e), the entire contents of which are hereby incorporated by reference.

### TECHNICAL FIELD

The disclosure relates in general to the suppression of audio feedback in audio systems, and more specifically, to an audio feedback suppression method, system, one or more computer programs, and non-transitory computer-readable storage medium.

### BACKGROUND

In audio systems, audio feedback (acoustic feedback, howling, or simply feedback) is an undesirable phenomenon caused by a microphone picking up sound output by a speaker. For example, in closed-loop audio systems, where audio from the microphone is amplified and output by the speaker, the microphone can pick up the amplified signal, causing particular audio frequencies to become reinforced, leading to signal runaway in which the audio signal can become extremely loud. Such loud audio signals may be undesirable.

Existing digital audio processing methods may use a filter to filter out unwanted audio feedback using an auto-notching filter. Such methods may include i) identifying feedback frequency candidates after performing a frequency analysis on the audio signal, ii) distinguishing the frequency feedback candidates from the audio signal, and iii) applying the notching filter to suppress frequencies (i.e., suppress power, energy, signal strength etc. at frequencies) determined to be feedback frequencies.

However, issues remain with such implementations.

For example, in order to accurately detect frequencies as feedback frequencies, frequency analysis must be performed on a relatively large analysis window or frame (e.g., a series of samples representing a portion of the audio signal) in order to achieve an acceptable frequency resolution. Thus, the frequency analysis may be computationally expensive, and require a relatively large memory due to the relatively large analysis window. Further, if a low frequency resolution is used, frequencies other than feedback (e.g., frequencies corresponding to speech) may be suppressed.

Further, due to the size (i.e., length) of the analysis window, the detection speed of the feedback frequencies may be slow. For example, in order for feedback frequencies to be identified, multiple frequency analyses may need to be performed in order to identify a frequency which exhibits properties of signal runaway before steps may be taken to suppress feedback frequencies. The performance of multiple frequency analyses based on large analysis windows before feedback frequencies may be suppressed may slow down the detection speed.

In some implementations, analysis window size etc. may be configured to balance detection accuracy with detection speed, however, it is desirable to improve audio feedback suppression.

According to a first aspect, an audio feedback suppression method is provided. The method comprises performing a first frequency analysis of an audio signal at a first frequency resolution; performing a second frequency analysis of the audio signal at a second frequency resolution higher than the first frequency resolution; and suppressing audio feedback frequencies in the audio signal based on the first frequency analysis and the second frequency analysis.

In some arrangements, the second frequency analysis may be based on the first frequency analysis.

In some arrangements, performing the first frequency analysis may comprise determining, from a first frequency domain representation of the audio signal, one or more first candidate audio feedback frequencies; performing the second frequency analysis comprises determining, from a second frequency domain representation of the audio signal, one or more corresponding audio feedback frequencies based on the one or more first candidate audio feedback frequencies; and said suppressing may comprise suppressing audio feedback frequencies in the audio signal based on the one or more corresponding audio feedback frequencies.

In some arrangements, determining, from the second frequency domain representation of the audio signal, the one or more corresponding audio feedback frequencies based on the one or more first candidate audio feedback frequencies, may comprise: determining, as the one or more corresponding audio feedback frequencies: one or more frequencies from the second frequency domain representation of the audio signal within the first candidate audio feedback frequencies which have a difference in strength over neighboring frequencies within the first candidate audio feedback frequencies greater than a strength difference threshold.

In some arrangements, determining, from the first frequency domain representation of the audio signal, the one or more first candidate audio feedback frequencies may comprise: determining, as the one or more first candidate audio feedback frequencies: one or more frequencies from the first frequency domain representation of the audio signal which have increased in strength by more than a strength threshold relative to one or more initial first frequency analyses performed on the audio signal at the first frequency resolution prior to the first frequency analysis; and/or one or more frequencies from the first frequency domain representation of the audio signal which have a difference in strength over neighboring frequencies greater than a strength difference threshold.

In some arrangements, suppressing audio feedback frequencies in the audio signal based on the first frequency analysis and the second frequency analysis may further comprise: determining, as one or more additional audio feedback frequencies: one or more additional frequencies from the first frequency domain representation of the audio signal which have increased in strength by more than a strength threshold relative to one or more initial first frequency analyses performed on the audio signal at the first frequency resolution prior to the first frequency analysis; and one or more additional frequencies from the first frequency domain representation of the audio signal which have a difference in strength over neighboring frequencies greater than a strength difference threshold, and suppressing audio feedback frequencies in the audio signal based on the one or more corresponding audio feedback frequencies and the one or more additional audio feedback frequencies.

In some arrangements, suppressing the audio feedback frequencies in the audio signal based on the first frequency analysis and the second frequency analysis may comprise: configuring, based on the first frequency analysis and the second frequency analysis, a filter configured to suppress the audio feedback frequencies in the audio signal; and applying the filter to the audio signal.

In some arrangements, the method may further comprise, prior to performing the first frequency analysis, sampling the audio signal at a first sampling rate to obtain a first set of samples, wherein the first frequency analysis is based on the first set of samples.

In some arrangements, the method may further comprise, prior to performing the second frequency analysis, sampling the audio signal at a second sampling rate to obtain a second set of samples, wherein the second frequency analysis is based on the second set of samples.

In some arrangements, the first frequency resolution may be determined according to a first quotient of the first sampling rate and a first number of samples in the first set of samples, and the second frequency resolution may be determined according to a second quotient of the second sampling rate and a second number of samples in the second set of samples, wherein the second quotient is smaller than the first quotient. In some arrangements, the second quotient is at least two times smaller than the first quotient.

In some arrangements, the second sampling rate may be less than the first sampling rate; and/or the second sampling rate may be a downsampled sampling rate of the first sampling rate.

In some arrangements, performing the first frequency analysis may comprise performing a Fast Fourier Transform on the first set of samples to generate the first frequency domain representation of the audio signal; and/or performing the second frequency analysis may comprise performing a Fast Fourier Transform on the second set of samples to generate the second frequency domain representation of the audio signal.

In a second aspect, one or more computer programs are provided. The one or more computer programs comprise instructions which, when executed by a computer, cause the computer to carry out any of the methods of the first aspect.

In a third aspect a computer system is provided. The computer system comprises: one or more processors; and memory, wherein the one or more computer programs of the second aspect are stored in the memory, and are configured to be executed by the one or more processors.

In a fourth aspect, a non-transitory computer-readable storage medium is provided. The non-transitory computer-readable storage medium has the one or more computer programs of the second aspect stored thereon.

### BRIEF DESCRIPTION OF THE FIGURES

Reference may be made by way of example only to the following drawings, in which:

FIG. 1 is a flow diagram 100 representing an audio suppression method which serves as a comparative example useful for understanding the present invention;

FIG. 2 is a flow diagram 200 representing an audio suppression method according to an embodiment of the present invention;

FIG. 3 is a flow diagram 300 representing an audio feedback suppression method according to an embodiment of the present invention; and

FIG. 4 is a block diagram of an information processing apparatus 400.

### DETAILED DESCRIPTION

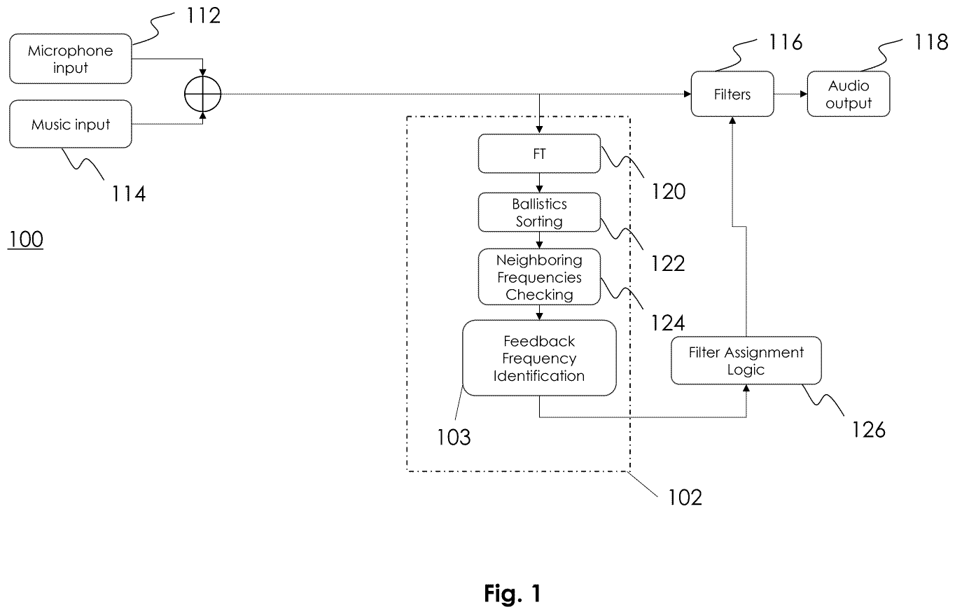

FIG. 1 is a flow diagram 100 representing an audio feedback suppression method which serves as a comparative example (and which introduces processes and techniques) useful for understanding the present invention.

A microphone input 112 and a music input 114 are combined to produce an audio signal which is supplied to one or more filters 116. The audio signal is filtered by the one or more filters 116 to provide a filtered audio signal which is provided to an audio output 118.

The microphone input 112 may correspond to an audio signal representative of speech or vocals, and the music input 114 may correspond to an audio signal representative of a backing track. The audio output 118 may be a speaker configured to output the filtered audio signal.

The audio signal is also subjected to a frequency analysis 102. The frequency analysis 102 comprises a frequency transform 120, ballistics sorting 122, neighboring frequencies checking 124, and feedback frequency identification 103.

In frequency transform 120, time-domain to frequency-domain conversion is performed (using e.g., a Fourier Transform, FT) such that the audio signal is transformed into a frequency-domain representation of the audio signal. Prior to the frequency transform 120, the frequency analysis 102 may also include the step of sampling the audio signal to generate a first set of samples upon which the frequency transform 120 may be based (not shown in FIG. 1).

Following the frequency transform 120, ballistics sorting 122 is performed, in which one or more frequencies from the frequency-domain representation of the audio signal which have increased in strength by more than a strength threshold relative to one or more initial frequency analyses performed on the audio signal prior to the frequency analysis 102 are determined.

Ballistics sorting may identify one or more frequencies in the audio signal which have increased in strength (i.e., one or more frequencies whose frequency components in the frequency domain representation of the audio signal have increased) relative to one or more previous frequency analyses, which may indicate signal runaway in respect of these one or more frequencies. For example, feedback frequencies often appear to increase in strength across multiple/successive frequency analyses as a result of the feedback frequencies cycling through the audio system. The one or more previous frequency analyses may refer to one or more previous instances of frequency analysis 102 performed on the audio signal at an earlier time (in which previous frequency-domain representations of the audio signal may have been obtained, and to which the frequency-domain representation of the (current/present) frequency analysis 102 may be compared).

The one or more frequencies in the audio signal which have increased in strength may have increased in strength by an amount larger than a strength threshold. The strength threshold may correspond to a factor by which the strength of a particular frequency has increased relative to the (same) frequency in one or more previous frequency analyses, or a predetermined value of strength by which the frequency has increased compared to the (same) frequency in one or more previous frequency analyses.

While one or more frequencies have been described above, the one or more frequencies may comprise one or more frequency ranges. For example, a frequency-domain representation may include a series of frequency bins representing discrete intervals into which the frequency spectrum is divided. Each frequency bin may correspond to a range of frequencies over which the energy of the audio signal is represented.

Following the ballistics sorting 122, neighboring frequencies checking 124 is performed, in which one or more frequencies from the frequency-domain representation of the audio signal which have a difference in strength over neighboring frequencies greater than a strength difference threshold are determined.

Neighboring frequencies checking may identify one or more frequencies in the audio signal which appear to have relatively high strength (i.e., a difference in strength over neighboring frequencies greater than a strength difference threshold) in comparison to neighboring (i.e., surrounding) frequencies. Feedback frequencies often appear as peaks/spikes in a frequency-domain representation of an audio signal, and so identification of one or more frequencies having relatively large/high strength compared to neighboring frequencies may indicate signal runaway in respect of those one or more frequencies.

The strength difference threshold may correspond to a factor by which the strength of a particular frequency is greater than one or more neighboring frequencies, or a predetermined value of strength difference by which the frequency is greater than one or more neighboring frequencies.

The neighboring frequencies may correspond to frequencies within a neighbor frequency range comprising a range of frequencies higher and lower than the frequency in the audio signal which is being analyzed. For example, a given frequency may be compared to frequencies up to X Hz higher than the given frequency and up to Y Hz lower than the given frequency in order to determine whether the given frequency may be a feedback frequency. Values of X and Y may be determined according to a desired neighbor frequency range. The neighboring frequency range may correspond to one or more adjacent frequency bins.

Strength, as described above, may refer to e.g., an energy, power or other magnitude, of the one or more frequencies.

While one or more frequencies have again been described above in respect of the neighboring frequencies checking 124, the one or more frequencies may comprise one or more frequency ranges, as per the ballistics sorting 122.

Following the neighboring frequencies checking 124, feedback frequency identification 103 is performed in which feedback frequencies are identified based on the one or more frequencies identified by the ballistics sorting 122 and the one or more frequencies identified by the neighboring frequencies checking 124. The feedback frequencies may be identified by combining the frequencies identified by the ballistics sorting 122 and the neighboring frequencies checking 124.

The feedback frequencies are provided to filter assignment logic 126 which generates or configures one or more filters 116 to be applied to the audio signal to suppress feedback based on the identified feedback frequencies from feedback frequency identification 103. For example, the filter assignment logic 126 may generate coefficients used to design one or more notch filters configured to suppress the feedback frequencies (while not suppressing other frequencies).

The filters 116 generated by the filter assignment logic 126 are used to filter the audio signal, as described above.

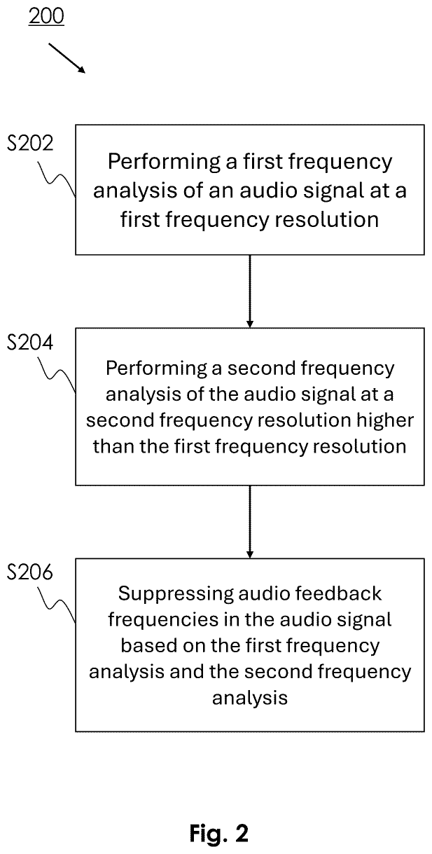

FIG. 2 is a flow chart of an audio feedback suppression method 200 according to the present invention.

Step S202 of method 200 comprises performing a first frequency analysis of an audio signal at a first frequency resolution.

Step S204 of method 200 comprises performing a second frequency analysis of the audio signal at a second frequency resolution higher than the first frequency resolution.

Step S206 of method 200 comprises suppressing audio feedback frequencies in the audio signal based on the first frequency analysis and the second frequency analysis.

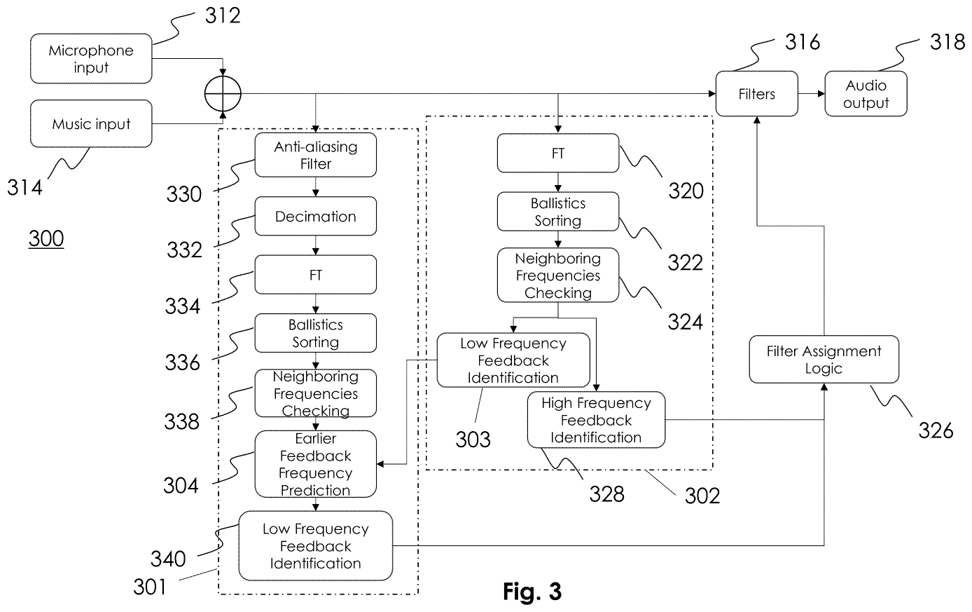

Further description of the steps of method 200 will be provided with respect to FIG. 3.

FIG. 3 is a flow diagram 300 representing an audio feedback suppression method according to an embodiment of the present invention. FIG. 3 is similar to FIG. 1, and like elements have been denoted with similar reference signs where possible.

Similarly to FIG. 1, in FIG. 3, a microphone input 312 and a music input 314 are combined to produce an audio signal which is supplied to one or more filters 316. The audio signal is filtered by the one or more filters 316 to provide a filtered audio signal which is provided to an audio output 318.

The audio signal is also subjected to a first frequency analysis 302 and a second frequency analysis 301.

The first frequency analysis 302 comprises a frequency transform 320, ballistics sorting 322, neighboring frequencies checking 324, low frequency feedback identification 303, and high frequency feedback identification 328.

The second frequency analysis 301 comprises filtering the audio signal using an anti-aliasing filter 330, decimation 332, a frequency transform 334, ballistics sorting 336, neighboring frequencies checking 338, receiving an earlier feedback frequency prediction 304 (from low frequency feedback identification 303 in the first frequency analysis 302), and low frequency feedback identification 340.

Feedback frequencies identified by low frequency feedback identification 340 and high frequency feedback identification 328 are provided to filter assignment logic 326, which generates or configures the one or more filters 316 based on identified feedback frequencies.

As described above, an audio feedback suppression method comprises performing a first frequency analysis of an audio signal at a first frequency resolution, performing a second frequency analysis of the audio signal at a second frequency resolution higher than the first frequency resolution, and suppressing audio feedback frequencies in the audio signal based on the first frequency analysis and the second frequency analysis.

That is, in contrast to the audio feedback suppression method of FIG. 1, the present invention suppresses audio feedback based on (determinations made by/results of) two separate frequency analyses performed at different frequency resolutions, which may lead to improved audio feedback suppression.

For example, in some arrangements, the first frequency analysis may represent a (lower resolution, less accurate) frequency analysis across a relatively large range of frequencies, and the second frequency analysis may represent a (higher resolution, more accurate) frequency analysis across a relatively smaller and low-frequency range of frequencies. Such an arrangement may provide improved low-frequency feedback suppression while also providing (adequate) mid- and high-frequency feedback suppression.

Suppressing audio feedback frequencies may correspond to suppressing power, energy, signal strength etc. of the audio signal at the audio feedback frequencies.

In some arrangements, the second frequency analysis 301 may be based on the first frequency analysis 302. For example, the second frequency analysis 301 may make use of a determination made by/result of the first frequency analysis 302 in order to provide a result of the second frequency analysis 301.

In some arrangements, performing the first frequency analysis 302 may comprise determining, from a first frequency domain representation of the audio signal, one or more first candidate audio feedback frequencies. Performing the second frequency analysis 301 may comprise determining, from a second frequency domain representation of the audio signal, one or more corresponding audio feedback frequencies based on the one or more first candidate audio feedback frequencies. Said suppressing may comprise suppressing audio feedback frequencies in the audio signal based on the one or more corresponding audio feedback frequencies. For example, said suppressing may comprise suppressing one or more of the one or more corresponding audio feedback frequencies.

The one or more first candidate audio feedback frequencies may be one or more frequencies identified from the first frequency domain representation of the audio signal which may correspond to audio feedback frequencies.

The one or more corresponding audio feedback frequencies may be one or more frequencies identified from the second frequency domain representation of the audio signal which may correspond to audio feedback frequencies, and which have been identified based on the one or more first candidate audio feedback frequencies (i.e., one or more frequencies identified from the first frequency domain representation of the audio signal). For example, the one or more first candidate audio feedback frequencies may indicate potential feedback frequencies which have been identified using the first (low resolution, low accuracy) frequency analysis 302, and the second frequency analysis 301 may use these one or more frequencies identified from the first frequency domain representation of the audio signal to guide a determination of the one or more corresponding audio feedback frequencies.

In some arrangements, determining, from the second frequency domain representation of the audio signal, the one or more corresponding audio feedback frequencies based on the one or more first candidate audio feedback frequencies, may comprise determining, as the one or more corresponding audio feedback frequencies: one or more frequencies from the second frequency domain representation of the audio signal within the first candidate audio feedback frequencies which have a difference in strength over neighboring frequencies within the first candidate audio feedback frequencies greater than a strength difference threshold.

Effectively, the first frequency analyses determines one or more first candidate audio feedback frequencies which are increasing in strength (via e.g., a ballistics sorting process), and informs the second frequency analysis of these one or more first candidate audio feedback frequencies. The second frequency analysis can therefore skip making such a determination itself, and determine one or more corresponding audio feedback frequencies by looking to areas in the second frequency domain representation of the audio signal which correspond to the one or more first candidate audio feedback frequencies (which are known to be feedback frequencies), and more accurately detect feedback frequencies within the one or more first candidate audio feedback frequencies (via e.g., a neighboring frequencies checking process).

For example, one or more frequencies (or frequency ranges) in the second frequency-domain representation of the audio signal which are part of/comprised in/correspond to the one or more first candidate audio feedback frequencies (or frequency ranges) may be determined as the one or more corresponding audio feedback frequencies based on the strength of the one or more frequencies (or frequency ranges) in the second frequency-domain representation compared to neighboring (or surrounding) frequencies which are also part of/comprised in/correspond to the one or more first candidate audio feedback frequencies (or frequency ranges).

That is, the one or more corresponding audio feedback frequencies may effectively be determined from the second frequency-domain representation of the audio signal according to a neighboring frequencies checking 338 process only (without the need for ballistics sorting 336 to determine increasing strength, since the identification of frequencies which are increasing in strength has already been completed in the first frequency analysis 302).

In some arrangements, determining, from the first frequency domain representation of the audio signal, the one or more first candidate audio feedback frequencies comprises determining, as the one or more first candidate audio feedback frequencies: one or more frequencies from the first frequency domain representation of the audio signal which have increased in strength by more than a strength threshold relative to one or more initial first frequency analyses performed on the audio signal at the first frequency resolution prior to the first frequency analysis 302; and/or one or more frequencies from the first frequency domain representation of the audio signal which have a difference in strength over neighboring frequencies greater than a strength difference threshold.

That is, the one or more first candidate audio feedback frequencies may be determined according to a ballistics sorting process, and/or according to a neighboring frequencies checking process, as previously described with respect to FIG. 1.

In some arrangements, suppressing audio feedback frequencies in the audio signal based on the first frequency analysis 302 and the second frequency analysis 301 further may comprise determining, as one or more additional audio feedback frequencies: one or more additional frequencies from the first frequency domain representation of the audio signal which have increased in strength by more than a strength threshold relative to one or more initial frequency analyses performed on the audio signal at the first frequency resolution prior to the first frequency analysis 302; and/or one or more additional frequencies from the first frequency domain representation of the audio signal which have a difference in strength over neighboring frequencies greater than a strength difference threshold. Suppressing audio feedback frequencies in the audio signal based on the first frequency analysis 302 and the second frequency analysis 301 further may further comprise suppressing audio feedback frequencies in the audio signal based on the one or more corresponding audio feedback frequencies and the one or more additional audio feedback frequencies. For example, said suppressing may comprise suppressing one or more of the one or more corresponding audio feedback frequencies and one or more of the one or more additional audio feedback frequencies.

The one or more additional audio feedback frequencies may correspond to one or more frequencies above the Nyquist Frequency of the second frequency analysis 301, and may represent high-frequency feedback frequencies. The one or more first candidate audio feedback frequencies may correspond to one or more frequencies below or equal to the Nyquist Frequency of the second frequency analysis 301, and may represent low-frequency feedback frequencies.

That is, feedback in the audio signal may be suppressed based on the one or more corresponding audio feedback frequencies (representing low frequency feedback frequencies identified from the second frequency-domain representation of the audio signal) and (additionally) the one or more additional audio feedback frequencies (representing other, possibly high-frequency feedback frequencies identified from the first frequency-domain representation of the audio signal, which may not be present/represented in the second frequency-domain representation of the audio signal).

The strength threshold and the strength difference threshold described with respect to the one or more additional audio feedback frequencies may be the same as or different from the strength threshold and the strength difference threshold described with respect to the one or more first candidate audio feedback frequencies.

In some arrangements, the method may further comprise performing the one or more initial first frequency analyses. Each of the one or more initial first frequency analyses may comprise steps equivalent to those carried out with respect to the first frequency analysis 302 as described herein. In some arrangements, a ballistics sorting process is not carried out during the first of the one or more initial first frequency analyses.

While reference has been made to one or more frequencies above, the one or more frequencies may comprise one or more frequency ranges, as previously described with respect to FIG. 1.

In some arrangements, suppressing the audio feedback frequencies in the audio signal based on the first frequency analysis 302 and the second frequency analysis 301 may comprise configuring (e.g., generating), based on the first frequency analysis and the second frequency analysis, a filter configured to suppress the audio feedback frequencies in the audio signal, and applying the filter to the audio signal.

The one or more filters 316 may comprise one or more notch filters. The one or more filters 316 may be designed/configured to suppress any one or more of the one or more corresponding audio feedback frequencies, and/or any one or more of the one or more additional audio feedback frequencies.

In some arrangements, the method may further comprise, prior to performing the first frequency analysis 302, sampling the audio signal at a first sampling rate to obtain a first set of samples, wherein the first frequency analysis 302 is based on the first set of samples. The first sampling rate may represent a nominal sampling rate (e.g., 48 kHz). The first set of samples may correspond to a plurality of samples sampled at the first sampling rate, and the number of samples may correspond to the size of a first analysis window which is subject to a frequency transform. Put another way, the first set of samples may represent a first analysis window (representing a portion of the audio signal) to be analyzed under the first frequency analysis 302.

In some arrangements, the method may further comprise, prior to performing the second frequency analysis 301, sampling the audio signal at a second sampling rate to obtain a second set of samples, wherein the second frequency analysis 301 is based on the second set of samples. The second sampling rate may represent a sampling rate less than the first/nominal sampling rate (e.g., 6 kHz). The second set of samples may correspond to a plurality of samples sampled at the second sampling rate, and the number of samples may correspond to the size of a second analysis window which is subject to a frequency transform. Put another way, the second set of samples may represent a second analysis window (representing a portion of the audio signal) to be analyzed under the second frequency analysis.

Sampling the audio signal may be performed through analogue-to-digital conversion, using e.g., an analogue-to-digital converter, ADC.

In some arrangements, the first frequency resolution may be determined according to a first quotient of the first sampling rate and a first number of samples in the first set of samples. The first frequency resolution may define the size of (or space between) frequency bins in the first frequency-domain representation of the audio signal into which frequency components of the audio signal may be divided.

Frequency resolution may be defined according to the following equation:

$$Frequency Resolution = \frac{F s}{N}$$

where Fs represents the sampling rate (or sampling frequency), and N represents the number of samples.

A frequency resolution may be provided in Hz. A frequency resolution equal to a relatively small value may indicate that frequencies from the frequency-domain representation of the audio signal may be more accurately distinguished (i.e., separated into relatively small frequency bins). A frequency resolution equal to a relatively large value may indicate that frequencies from the frequency-domain representation of the audio signal cannot be as accurately distinguished as compared to a relatively small value (and therefore are separated into relatively large frequency bins).

A frequency resolution equal to a relatively small value may be described as high frequency resolution (where frequencies may be better distinguished). A frequency resolution equal to a relatively large value may be described as low frequency resolution (where frequencies are not able to be distinguished as well).

In some arrangements, the second frequency resolution is determined according to a second quotient of the second sampling rate and a second number of samples in the second set of samples, wherein the second quotient is smaller than the first quotient.

Where the second quotient is smaller than the first quotient, the second frequency resolution may be said to be higher than the first frequency resolution. That is, the second frequency analysis (at the second frequency resolution) may more accurately distinguish frequencies in the frequency-domain representation of the audio signal than the first frequency analysis (at the first frequency resolution).

In some arrangements, the second quotient may be at least two times smaller than the first quotient. In this way, the second frequency resolution may be at least twice that of the first frequency resolution. In some arrangements, the second quotient may be four or eight times smaller than the first quotient. In this way, the second frequency resolution may be four or eight times that of the first frequency resolution.

In some arrangements, the second sampling rate is less than the first sampling rate. As described above, the sampling rate may influence the frequency resolution, and in a case where the number of first samples is equal to the number of second samples, that the second sampling rate is less than the first sampling rate would lead to a second frequency resolution which is higher than the first frequency resolution.

In some arrangements, the second sampling rate is a downsampled sampling rate of the first sampling rate. For example, the second sampling rate may correspond to a sampling rate in which 1 in every X samples sampled at the first sampling rate are retained as part of the set of second samples.

To continue the example above, where the first sampling rate is 48 kHz, the second sampling rate may be 6 kHz, where the second sampling rate may be referred to as a downsampled sampling rate in which 1 in every 8 samples sampled at the first sampling rate are retained as part of the set of second samples. Because the second sampling rate is lower than the first sampling rate, the maximum frequency which may be detected is also lower (e.g., 3 kHz, the Nyquist frequency). The second sampling rate may therefore correspond to a second frequency analysis which may be a low-frequency frequency analysis.

In some arrangements, performing the first frequency analysis may comprise performing a Fast Fourier Transform, FFT, on the first set of samples to generate the first frequency domain representation of the audio signal. In some arrangements, performing the second frequency analysis comprises performing a Fast Fourier Transform, FFT, on the second set of samples to generate the second frequency domain representation of the audio signal. This may be performed by frequency transform 320 and frequency transform 334, respectively.

The Fast Fourier Transform may be one example of an appropriate process in which the time-domain audio signal may be transformed into the first and/or second frequency domain representation of the audio signal.

In some arrangements, the method may further comprise, prior to sampling the audio signal at the second sampling rate, applying an anti-aliasing filter to the audio signal, and sampling the filtered audio signal at the second sampling rate to obtain the second set of samples sampled at the second sampling rate. This may be performed by anti-aliasing filter 330 and decimation 332. Such an implementation may reduce potential aliasing where decimated samples obtained at a higher sampling rate are otherwise used as the second set of samples.

The second sampling rate may still be referred to as a downsampled sampling rate of the first sampling rate, despite the signal being sampled independently to produce two different sets of samples. For example, a downsampled sampling rate may refer to a sampling rate which is an integer multiple times lower than the first sampling rate.

Although not necessary in order to carry out the invention, in some arrangements, suppressing audio feedback frequencies in the audio signal based on the first frequency analysis 302 and the second frequency analysis 301 further comprises determining, as one or more further audio feedback frequencies: one or more frequencies from the second frequency domain representation of the audio signal which have increased in strength by more than a strength threshold relative to one or more initial second frequency analyses performed on the audio signal at the second frequency resolution prior to the second frequency analysis; and one or more frequencies from the second frequency domain representation of the audio signal which have a difference in strength over neighboring frequencies greater than a strength difference threshold, and suppressing the audio feedback frequencies in the audio signal based on the one or more corresponding audio feedback frequencies and the one or more further feedback frequencies (and the one or more additional audio feedback frequencies).

That is, in addition to determining feedback frequencies based on the one or more first candidate audio feedback frequencies from the first frequency analysis 302, feedback frequencies may further be determined based on ballistics sorting 336 and neighboring frequencies checking 338 processes performed as part of the second frequency analysis 301 (e.g., based on one or more previous second frequency analyses).

In some arrangements, the method may further comprise performing the one or more initial second frequency analyses. Each of the one or more initial second frequency analyses may comprise steps equivalent to those carried out with respect to the second frequency analysis 301 as described herein. In some arrangements, a ballistics sorting process 336 is not carried out during the first of the one or more initial second frequency analyses.

The strength threshold and the strength difference threshold described with respect to the one or more further audio feedback frequencies may be the same as or different from the strength threshold and the strength difference threshold described with respect to the one or more first candidate audio feedback frequencies (and/or the one or more additional audio feedback frequencies).

The one or more filters 316 may comprise one or more notch filters. The one or more filters may be designed/configured to suppress any one or more of the one or more corresponding audio feedback frequencies, and/or any one or more of the one or more additional audio feedback frequencies and/or any one or more of the one or more further audio feedback frequencies.

The above steps may be repeated in order to continue to suppress feedback in e.g., a continuous audio signal.

In some arrangements, audio feedback in the audio may be suppressed (i.e., one or more filters may be generated) based on the one or more first candidate audio feedback frequencies (and the one or more additional audio feedback frequencies) while the second frequency analysis is still being performed. That is, while waiting for the second frequency analysis to be completed, filtering may be performed based on the first frequency analysis only.

A comparative example implementation will now be described with reference to FIG. 1.

The audio signal is subject to the frequency analysis 102 which includes sampling 4096 samples from the audio signal at a sampling rate of 48 KHz. A frequency transform 120 is performed to transform the samples into the frequency-domain representation of the audio signal, where the frequency analysis has a frequency resolution of 48 KHz/4096=11.7 Hz, and a Nyquist Frequency of 24 kHz.

Ballistics sorting 122 is performed in which one or more frequencies (from the frequency-domain representation of the audio signal) which have increased in strength relative to (the frequency-domain representations of the audio signal of) previous frequency analyses are determined as one or more audio feedback frequencies. For example, the one or more feedback frequencies may include a frequency range of 0 to 11.7 Hz corresponding to a frequency bin of the frequency domain representation of the audio signal, where this frequency bin has increased in strength relative to the previous frequency analyses.

Neighboring frequencies checking 124 is performed in which one or more frequencies which have a strength above a strength difference threshold relative to neighboring frequencies are determined as one or more audio feedback frequencies. For example, the one or more audio feedback frequencies may include a frequency range of 0 to 11.7 Hz, where this frequency range has a strength above a strength difference threshold relative to neighboring frequencies (e.g., a neighboring, adjacent frequency bin). For simplicity, this frequency range is the same frequency range as determined in the ballistics sorting 122.

The one or more audio feedback frequencies are supplied to the filter assignment logic 126 by frequency feedback identification 103.

The filter assignment logic 126 generates or configures a notch filter which suppresses frequencies according to the one or more audio feedback frequencies. For example, the notch filter is generated such that it suppresses frequencies in the ranges 0 to 11.7 Hz.

The notch filter may then be applied to the audio signal in order to suppress the frequencies identified as feedback frequencies in order to reduce audio feedback.

An example implementation will now be described with reference to FIG. 3.

The audio signal is subject to the first frequency analysis 302 which includes sampling 1024 first samples from the audio signal at a first sampling rate of 48 KHz. A frequency transform 320 is performed to transform the first samples into the first frequency-domain representation of the audio signal, where the first frequency analysis has a first frequency resolution of 48 kHz/1024=46.8 Hz, and a Nyquist Frequency of 24 kHz.

Since the sampling rate is the same as that in the comparative example implementation, and since the number of samples used in the first frequency analysis is only 1024 (rather than 4096), four first frequency analyses may be performed in the same time it takes to perform one frequency analysis in the comparative example implementation. This enables feedback frequencies to be identified more quickly using e.g., ballistics processing, since comparisons to previous first frequency analyses may be made more quickly (because they are generated more often), albeit at lower frequency resolution. Further, since the first frequency analyses require only 1024 samples (rather than 4096), hardware (e.g., memory) and processing requirements (of the system carrying out the first frequency analyses) may be relaxed.

Ballistics sorting 322 is performed in which one or more frequencies (from the first frequency-domain representation of the audio signal) which have increased in strength relative to the (frequency-domain representations of the audio signal of) previous first frequency analyses are determined as one or more first candidate audio feedback frequencies. For example, the one or more first feedback frequency candidates may include a frequency range of 0 to 46.8 Hz corresponding to a frequency bin of the first frequency domain representation of the audio signal, where this frequency bin has increased in strength relative to the previous first frequency analyses.

Neighboring frequencies checking 324 is performed in which one or more frequencies which have a strength above a strength difference threshold relative to neighboring frequencies are determined as one or more first candidate audio feedback frequencies. For example, the one or more first feedback frequency candidates may include a frequency range of 0 to 46.8 Hz, where this frequency range has a strength above a strength difference threshold relative to neighboring frequencies.

The one or more first candidate audio feedback frequencies are supplied to the second frequency analysis 301 by low-frequency feedback identification 303.

For simplicity, in this example, there are no one or more additional audio feedback frequencies, however if there were, the one or more additional audio feedback frequencies would be supplied to the filter assignment logic 326 by high-frequency feedback identification 328. Since four first frequency analyses may be performed in the same time as the frequency analysis in the comparative example implementation, the one or more additional audio frequencies (corresponding to e.g., high-frequency feedback frequencies) may be detected and suppressed more quickly in the example implementation.

The audio signal is also subject to the second frequency analysis 301 which includes filtering the audio signal using anti-aliasing filter 330, sampling 1024 second samples from the audio signal at a second sampling rate of 6 kHz, using decimation 332 (i.e., by effectively sampling 1 in every 8 samples as compared to the first sampling rate). Frequency transform 334 transforms the second samples into the second frequency-domain representation of the audio signal, where the second frequency analysis 301 has a second frequency resolution of 6 kHz/1024=5.8 Hz, and a Nyquist Frequency of 3 kHz.

Since the sampling rate is 8 times less than that in the comparative example implementation, and since the number of samples used in the second frequency analysis 301 is 1024 (e.g., sampled via decimation from 8192 original samples, and where 1024 samples is 4 times less than the 4096 samples in the comparative example implementation), one second frequency analysis may be performed in the same time it takes to perform two frequency analyses in the comparative example implementation described above. This enables feedback frequencies to be identified more accurately since the frequency resolution is higher, albeit within a smaller, low-frequency range (due to the 3 kHz Nyquist Frequency), and at a lower detection speed (since the second frequency analyses are generated less often).

The second frequency analysis 301 receives the first feedback frequency candidates from the first frequency analysis 302 at earlier feedback frequency prediction 304, and one or more corresponding audio feedback frequencies are determined from the second frequency domain representation of the audio signal. For example, based on the frequency range of 0 to 46.8 Hz received from the first frequency analysis 302, the one or more corresponding audio feedback frequencies may include a frequency range of 5.8 to 11.6 Hz determined from the (higher resolution) second frequency domain representation of the audio signal, where this corresponding audio feedback frequency range is determined to have a strength above a strength difference threshold compared to other frequencies (or frequency ranges) in the second frequency-domain representation of the audio signal.

By supplying the one or more first candidate audio feedback frequencies to the second frequency analysis 301, the second frequency analysis 301 may be informed of feedback frequency candidates earlier than if feedback frequencies were being determined solely according to the second frequency analysis, speeding up feedback frequency detection at higher accuracy. For example, instead of waiting for another second frequency analysis to be completed (in order to perform ballistics sorting), feedback frequencies may be determined from the second frequency-domain representation of the audio signal based on (more up-to-date) one or more first candidate audio feedback frequencies identified in the first frequency analysis (which are known to have increased based on ballistics sorting 322 in the first frequency analysis 302). That is, the low frequency feedback identification 303 first preliminarily determines potential low-frequency feedback candidate frequencies, such as first candidate audio feedback frequencies, with general resolution analysis (or low resolution analysis). These identified candidates are then passed to the earlier feedback frequency prediction 304 and further verified by the low frequency feedback identification 340 with higher-resolution analysis, to determine more accurate low-frequency feedback frequencies, which is subsequently provided to the filter assignment logic 326. By performing preliminary identification in the first stage (e.g., the first frequency analysis 302), followed by secondary confirmation in the second stage (e.g., the second frequency analysis 301), the two-stage division of labor enables faster decision-making and improves the accuracy of low-frequency feedback frequency identification.

The one or more corresponding audio feedback frequencies are supplied to the filter assignment logic 326 by low-frequency feedback identification 340.

The filter assignment logic 326 generates a notch filter which suppresses frequencies according to the one or more corresponding audio feedback frequencies. For example, the notch filter is generated such that it suppresses frequencies in the range of 5.8 to 11.6 Hz.

The notch filter may then be applied to the audio signal in order to suppress the frequencies identified as feedback frequencies in order to reduce audio feedback.

The notch filter may therefore more accurately suppress the feedback frequencies in the audio signal (compared to a notch filter designed only on one or more first candidate audio feedback frequencies determined in the first frequency analysis 302).

That is, in the same period of time:
2 frequency analyses may be performed according to the comparative example implementation, allowing a frequency range of 0 to 11.7 Hz to be suppressed based on ballistics sorting and neighboring frequencies checking.
8 first frequency analyses, and 1 second frequency analysis, may be performed. The first frequency analyses may determine one or more first candidate audio feedback frequencies which have increased in strength according to ballistics sorting, and provide these one or more first candidate audio feedback frequencies to the second frequency analysis. The second frequency analysis may then identify one or more corresponding audio feedback frequencies from the higher resolution frequency-domain representation of the audio signal, which may be within the one or more first candidate audio feedback frequencies, based on e.g., neighboring frequencies checking. According to the example implementation, this allows a (more accurate) frequency range of 5.8 Hz to 11.6 Hz to be suppressed in the same period time.

Overall, the method may both speed up the detection of, and more accurately suppress, feedback frequencies in the audio signal.

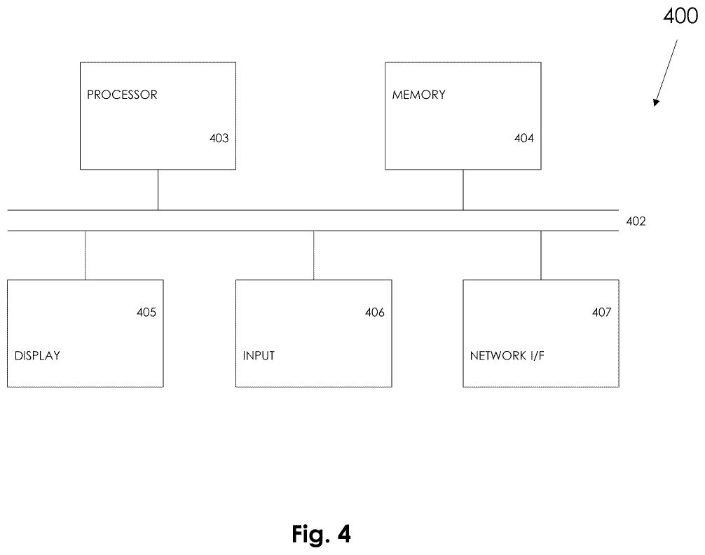

FIG. 4 is a block diagram of an information processing apparatus 400 or a computing device 400 or server 400, such as a (data storage) server, which may be used to implement some or all of the operations of a method(s) described herein, and perform some or all of the tasks of apparatus of an embodiment. The computing device 400 may be used to implement any of the method steps described above, e.g. any of steps S202 to S206.

The computing device 400 comprises a processor 403 and memory 404. Optionally, the computing device 400 also includes a network interface 407 for communication with other such computing devices, for example with other computing devices of invention embodiments. Optionally, the computing device 400 also includes one or more input mechanisms such as keyboard and mouse 406, and a display unit such as one or more monitors 405. These elements may facilitate user interaction. The components are connectable to one another via a bus 402.

The memory 404 may include a computer readable medium, which term may refer to a single medium or multiple media (e.g., a centralized or distributed database and/or associated caches and servers) configured to carry computer-executable instructions. Computer-executable instructions may include, for example, instructions and data accessible by and causing a computer (e.g., one or more processors) to perform one or more functions or operations. For example, the computer-executable instructions may include those instructions for implementing a method disclosed herein, or any method steps disclosed herein, for example any of steps S202 to S206. Thus, the term “computer-readable storage medium” may also include any medium that is capable of storing, encoding or carrying a set of instructions for execution by the machine and that cause the machine to perform any one or more of the method steps of the present disclosure. The term “computer-readable storage medium” may accordingly be taken to include, but not be limited to, solid-state memories, optical media and magnetic media. By way of example, and not limitation, such computer-readable media may include non-transitory computer-readable storage media, including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices).

The processor 403 is configured to control the computing device 400 and execute processing operations, for example executing computer program code stored in the memory 404 to implement any of the method steps described herein. The memory 404 stores data being read and written by the processor 403 and may store programs for executing any of the method steps described above. These entities may be in the form of code blocks which are called when required and executed in a processor.

As referred to herein, a processor may include one or more general-purpose processing devices such as a microprocessor, central processing unit, or the like. The processor may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor may also include one or more special-purpose processing devices such as an application specific integrated circuit (ASIC), a field programmable gate array (FPGA), a digital signal processor (DSP), network processor, or the like. In one or more embodiments, a processor is configured to execute instructions for performing the operations and operations discussed herein. The processor 403 may be considered to comprise any of the blocks, or units, or modules, described herein. Any operations described as being implemented by a block may be implemented as a method by a computer and e.g. by the processor 403.

The display unit 405 may display a representation of data stored and/or generated by the computing device 400, such as classification of a medical condition. For instance, the computing device 400 may be a device which accepts a sample as an input and determines a classification of a condition for the sample. The computing device 400 may be request access to a website/web page or server by communicating with another computing device (e.g. a server). The other computing device may store instructions for performing the methods herein and the computing device 400 may instruct the other computing device to provide a classification of the condition. The output may be shown as GUI windows and/or interactive representations enabling a user to interact with the computing device 400 by e.g. selection interaction, input text boxes, and/or any other output described above, and may also display a cursor and dialog boxes and screens enabling interaction between a user and the programs and data stored on the computing device. The input mechanisms 406 may enable a user to input data and instructions to the computing device 400. For example, the display unit may display a GUI including a user panel, or input space, for the user to interact. For instance, a user may input a sample and query the classification of the sample. The user may interact with the GUI and display to generate and view a determined answer. Of course, the method may be performed automatically without interaction with a user.

The network interface (network I/F) 407 may be connected to a network, such as the Internet, and is connectable to other such computing devices and/or servers via the network. The network I/F 407 may control data input/output from/to other apparatus via the network. Other peripheral devices such as microphone, speakers, printer, power supply unit, fan, case, scanner, trackerball etc may be included in the computing device 400.

Methods embodying the present invention may be carried out on a computing device/apparatus/server 400 such as that illustrated in FIG. 4. Such a computing device need not have every component illustrated in FIG. 4 and may be composed of a subset of those components. For example, the computing device 400 may comprise the processor 403 and the memory 404 connected to the processor 403. Or the computing device 400 may comprise the processor 403, the memory 404 connected to the processor 403, and the display 405. The processor 403 may be configured to perform the method stored in the memory 404 using, for example, the functions and/or architecture stored in the memory 404.

A method embodying the present invention may be carried out by a single computing device/server in communication with one or more (data storage) servers via a network. The computing device may be a data storage itself storing at least a portion of the data. The functions and/or architecture and/or method may be stored on the one or more data storage servers and the processor in the computing device may be configured to carry out the method steps.

A method embodying the present invention may be carried out by a plurality of computing devices operating in cooperation with one another. One or more of the plurality of computing devices may be a data storage server storing at least a portion of the data.

In one embodiment, the computing device 400 may be installed in, or connected to, an audio or audiovisual system that includes or is connected to a microphone device, such as a video conferencing system, teleconferencing system, audio system, broadcasting system, or karaoke system.

The invention may be implemented in digital electronic circuitry, or in computer hardware, firmware, software, or in combinations of them. The invention may be implemented as a computer program or computer program product, i.e., a computer program tangibly embodied in a non-transitory information carrier, e.g., in a machine-readable storage device, or in a propagated signal, for execution by, or to control the operation of, one or more hardware modules.

A computer program may be in the form of a stand-alone program, a computer program portion or more than one computer program and may be written in any form of programming language, including compiled or interpreted languages, and it may be deployed in any form, including as a stand-alone program or as a module, component, subroutine, or other unit suitable for use in a data processing environment. A computer program may be deployed to be executed on one module or on multiple modules at one site or distributed across multiple sites and interconnected by a communication network.

Method steps of the invention may be performed by one or more programmable processors executing a computer program to perform functions of the invention by operating on input data and generating output. Apparatus of the invention may be implemented as programmed hardware or as special purpose logic circuitry, including e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions coupled to one or more memory devices for storing instructions and data.

The above-described embodiments of the present invention may advantageously be used independently of any other of the embodiments or in any feasible combination with one or more others of the embodiments. The skilled person will appreciate that except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

1. An audio feedback suppression method, comprising:
performing a first frequency analysis of an audio signal at a first frequency resolution;
performing a second frequency analysis of the audio signal at a second frequency resolution higher than the first frequency resolution; and
suppressing audio feedback frequencies in the audio signal based on the first frequency analysis and the second frequency analysis.

2. The audio feedback suppression method of claim 1, wherein the second frequency analysis is based on the first frequency analysis.

3. The audio feedback suppression method of claim 1, wherein said performing the first frequency analysis comprises determining, from a first frequency domain representation of the audio signal, one or more first candidate audio feedback frequencies,
wherein said performing the second frequency analysis comprises determining, from a second frequency domain representation of the audio signal, one or more corresponding audio feedback frequencies based on the one or more first candidate audio feedback frequencies, and
wherein said suppressing comprises suppressing audio feedback frequencies in the audio signal based on the one or more corresponding audio feedback frequencies.

4. The audio feedback suppression method of claim 3, wherein said determining, from the second frequency domain representation of the audio signal, the one or more corresponding audio feedback frequencies based on the one or more first candidate audio feedback frequencies, comprises:
determining, as the one or more corresponding audio feedback frequencies, one or more frequencies from the second frequency domain representation of the audio signal within the first candidate audio feedback frequencies which have a difference in strength over neighboring frequencies within the first candidate audio feedback frequencies greater than a strength difference threshold.

5. The audio feedback suppression method of any of claim 3, wherein said determining, from the first frequency domain representation of the audio signal, the one or more first candidate audio feedback frequencies comprises determining, as the one or more first candidate audio feedback frequencies:
one or more frequencies from the first frequency domain representation of the audio signal which have increased in strength by more than a strength threshold relative to one or more initial first frequency analyses performed on the audio signal at the first frequency resolution prior to the first frequency analysis; and/or
one or more frequencies from the first frequency domain representation of the audio signal which have a difference in strength over neighboring frequencies greater than a strength difference threshold.

6. The audio feedback suppression method of claim 3, wherein said suppressing audio feedback frequencies in the audio signal based on the first frequency analysis and the second frequency analysis further comprises:
determining, as one or more additional audio feedback frequencies:
one or more additional frequencies from the first frequency domain representation of the audio signal which have increased in strength by more than a strength threshold relative to one or more initial first frequency analyses performed on the audio signal at the first frequency resolution prior to the first frequency analysis; and
one or more additional frequencies from the first frequency domain representation of the audio signal which have a difference in strength over neighboring frequencies greater than a strength difference threshold; and
suppressing audio feedback frequencies in the audio signal based on the one or more corresponding audio feedback frequencies and the one or more additional audio feedback frequencies.

7. The audio feedback suppression method of claim 3, wherein said suppressing the audio feedback frequencies in the audio signal based on the first frequency analysis and the second frequency analysis comprises:
configuring, based on the first frequency analysis and the second frequency analysis, a filter configured to suppress the audio feedback frequencies in the audio signal; and
applying the filter to the audio signal.

8. The audio feedback suppression method of claim 3, further comprising, prior to performing the first frequency analysis, sampling the audio signal at a first sampling rate to obtain a first set of samples,
wherein the first frequency analysis is based on the first set of samples.

9. The audio feedback suppression method of claim 8, further comprising, prior to performing the second frequency analysis, sampling the audio signal at a second sampling rate to obtain a second set of samples,
wherein the second frequency analysis is based on the second set of samples.

10. The audio feedback suppression method of claim 9, wherein the first frequency resolution is determined according to a first quotient of the first sampling rate and a first number of samples in the first set of samples, and the second frequency resolution is determined according to a second quotient of the second sampling rate and a second number of samples in the second set of samples, wherein the second quotient is smaller than the first quotient, and
wherein the second quotient is at least two times smaller than the first quotient.

11. The audio feedback suppression method of claim, wherein the second sampling rate is less than the first sampling rate, and/or
wherein the second sampling rate is a downsampled sampling rate of the first sampling rate.

12. The audio feedback suppression method of claim 8, wherein said performing the first frequency analysis comprises performing a Fast Fourier Transform on the first set of samples to generate the first frequency domain representation of the audio signal; and/or
wherein said performing the second frequency analysis comprises performing a Fast Fourier Transform on the second set of samples to generate the second frequency domain representation of the audio signal.

13. A computer system comprising:
one or more processors; and
a memory, storing one or more computer programs comprising instructions which, when executed by the one or more processors, cause the one or more processors to carry out the method of claim 1.

14. A non-transitory computer-readable storage medium storing thereon one or more computer programs comprising instructions which, when executed by a computer, cause the computer to carry out the method of claim 1.
